(19) United States
(12) Patent Application Publication
(10) Pub. No.: US 2017/0036182 A1
(43) Pub. Date: Feb. 9, 2017

(54) Batch Preparation System

(71) Applicant: Summers Manufacturing Company, Inc., Delvis Lake, ND (US)

(72) Inventors: Travis E. Westlind, Devils Lake, ND (US); Paul J. Wilhelmi, Devils Lake, ND (US); David J. Sobolik, Devils Lake, ND (US)

(21) Appl. No.: 15/230,999

(22) Filed: Aug. 8, 2016

Related U.S. Application Data
(60) Provisional application No. 62/282,615, filed on Aug. 7, 2015.

(51) Int. Cl. B01F 15/00; B01F 13/00; B01F 5/06; B01F 15/02

(52) U.S. Cl. CPC B01F 15/00136; B01F 15/0243; B01F 13/0032; B01F 15/00032; B01F 15/0235; B01F 5/0609; B01F 2215/0009

(57) ABSTRACT

A batch preparation system for quickly and efficiently mixing materials with a fluid, such as to fill an agricultural reservoir tank. The batch preparation system generally includes a frame, a tank unit comprising a plurality of tanks connected to the frame, and a transfer system for mixing materials stored in the tanks with fluids being pumped from a fluid source. The tanks are interconnected to form a unitary tank unit which is positioned on the frame. The transfer system includes a manifold pipe which is fluidly connected to each of the tanks. An eductor is connected to the manifold such that the materials from each tank are drawn by suction through the eductor into a mixing conduit, where the materials are mixed with the fluid from the pump. The resulting mixture is dispensed through a transfer outlet, such as to a reservoir tank.

### CROSS REFERENCE TO RELATED APPLICATIONS

I hereby claim benefit under Title 35, United States Code, Section 119(e) of U.S. provisional patent application Ser. No. 62/282,615 filed Aug. 7, 2015. The 62/282,615 application is currently pending. The 62/282,615 application is hereby incorporated by reference into this application.

### STATEMENT REGARDING FEDERALLY SPONSORED RESEARCH OR DEVELOPMENT

Not applicable to this application.

### BACKGROUND

Field

Example embodiments in general relate to a batch preparation system for quickly and efficiently mixing materials with a fluid, such as to fill an agricultural reservoir tank.

Related Art

Any discussion of the related art throughout the specification should in no way be considered as an admission that such related art is widely known or forms part of common general knowledge in the field.

Batching of materials with a fluid is common in many industries, including agriculture and construction. For example, in agriculture, it is often desired to mix certain chemicals with water for dispensing via a sprayer onto crops. A very common example would be pesticide, nutrient, or insecticide applications. In construction, it is often necessary to mix various slurries and the like.

When batching materials such as chemicals, it can be extremely important that accurate measurements are taken and cross-contamination does not occur. Previous systems have been known to pump mixtures of chemicals and water through a pump. The pump can become degraded or contaminated, which can result in dangerous situations if future chemicals are not compatible with previously-mixed chemicals. Previous systems often lack the capability to control order of chemical insertion into spray, which can be a safety concern.

It can also be extremely time intensive to batch chemicals using preexisting systems. Tanks are often disconnected and need to be set up a certain way. Transport of multiple tanks and conduits is also cumbersome or time consuming and can act as an impediment to batching operations that span a large area.

### SUMMARY

An example embodiment of the present invention is directed to a batch preparation system. The batch preparation system includes a frame, a tank unit comprising a plurality of tanks connected to the frame, and a transfer system for mixing materials stored in the tanks with fluids being pumped from a fluid source. The tanks are interconnected to form a unitary tank unit which is positioned on the frame. The transfer system includes a manifold pipe which is fluidly connected to each of the tanks. An eductor is connected to the manifold such that the materials from each tank are drawn by suction through the eductor into a mixing conduit, where the materials are mixed with the fluid from the pump. The resulting mixture is dispensed through a transfer outlet, such as to a reservoir tank.

There has thus been outlined, rather broadly, some of the features of the batch preparation system in order that the detailed description thereof may be better understood, and in order that the present contribution to the art may be better appreciated. There are additional features of the batch preparation system that will be described hereinafter and that will form the subject matter of the claims appended hereto. In this respect, before explaining at least one embodiment of the batch preparation system in detail, it is to be understood that the batch preparation system is not limited in its application to the details of construction or to the arrangements of the components set forth in the following description or illustrated in the drawings. The batch preparation system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a frontal perspective view of a batch preparation system in accordance with an example embodiment.

FIG. 2 is a frontal perspective view of a batch preparation system with the tank cover opened in accordance with an example embodiment.

FIG. 3 is a rear perspective view of a batch preparation system in accordance with an example embodiment.

FIG. 4 is a frontal view of a batch preparation system in accordance with an example embodiment.

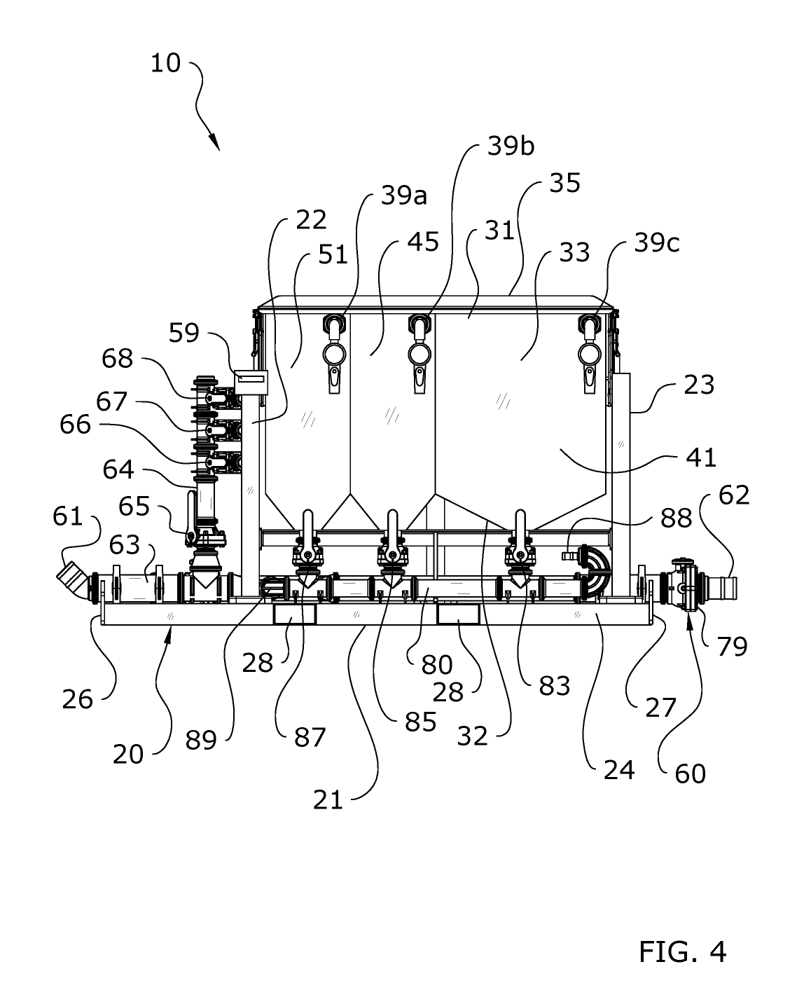

FIG. 5 is a rear view of a batch preparation system in accordance with an example embodiment.

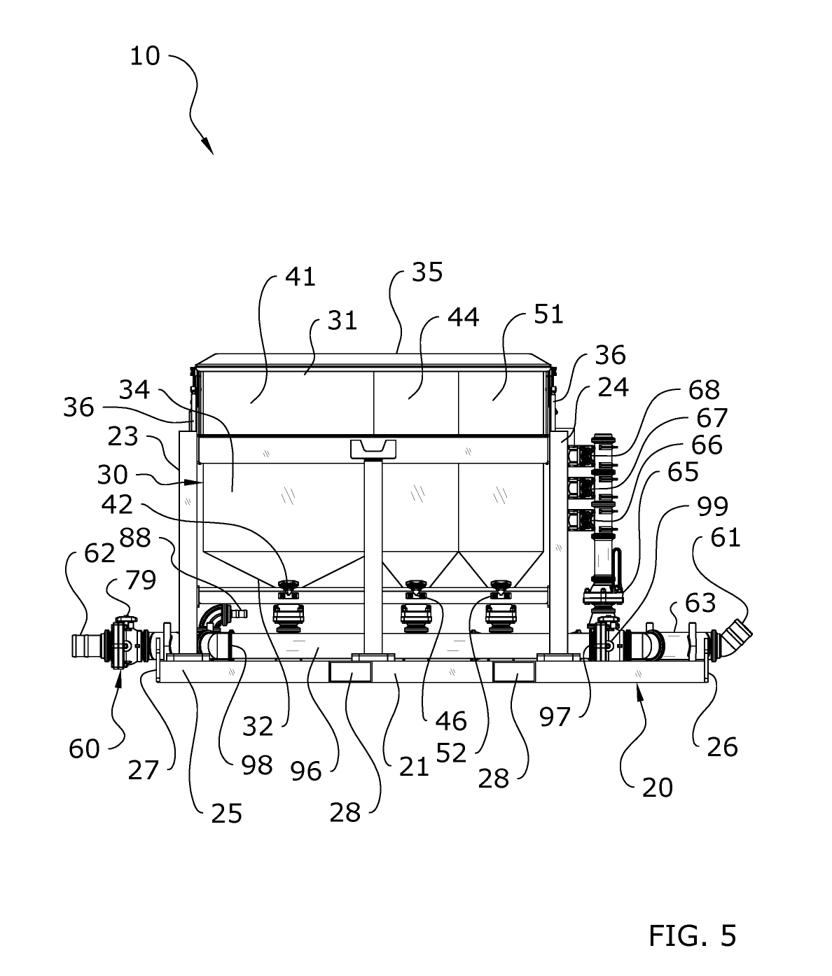

FIG. 6 is a top view of a batch preparation system in accordance with an example embodiment.

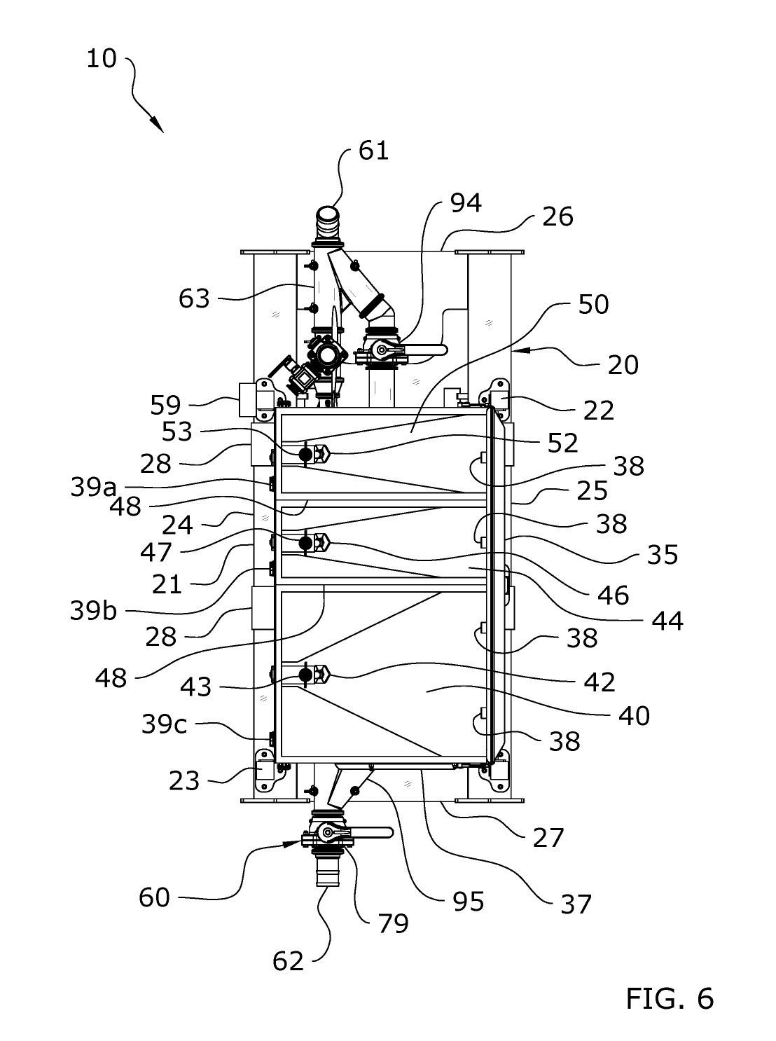

FIG. 7 is a bottom view of a batch preparation system in accordance with an example embodiment.

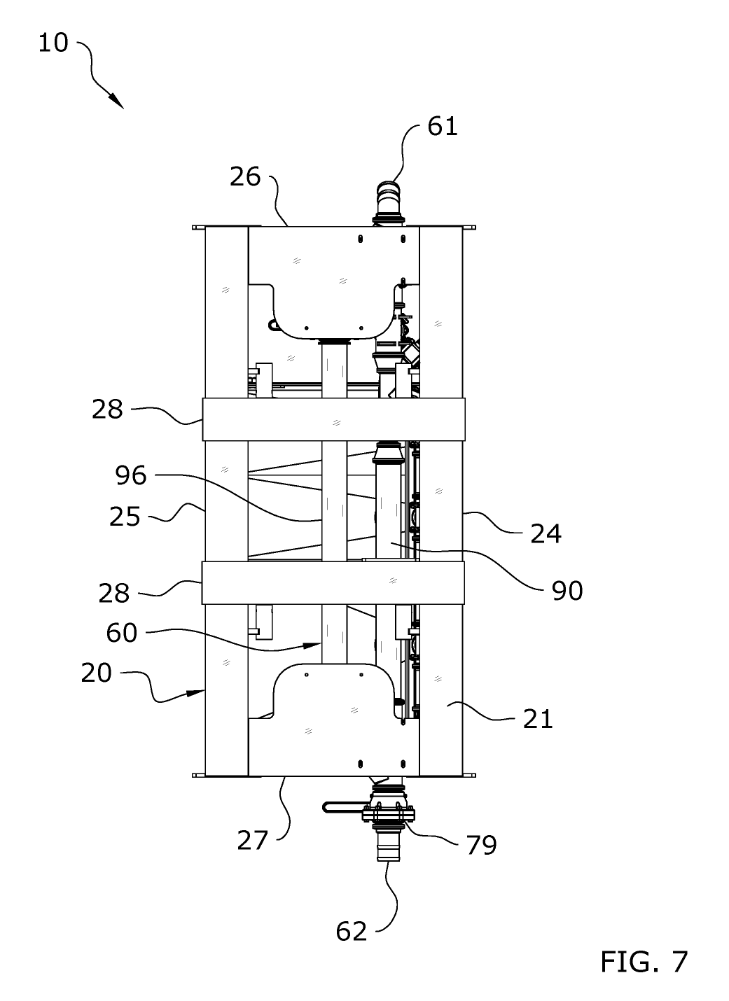

FIG. 8 is a first side view of a batch preparation system in accordance with an example embodiment.

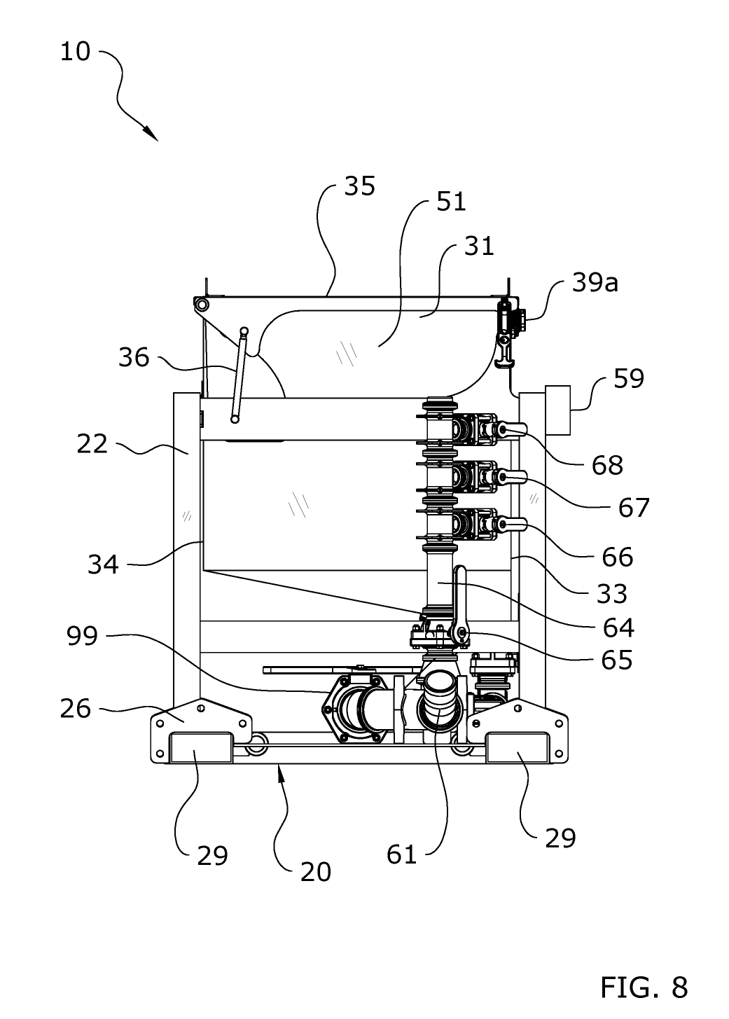

FIG. 9 is a second side view of a batch preparation system in accordance with an example embodiment.

FIG. 10 is a frontal perspective view of a transfer system for a batch preparation system in accordance with an example embodiment.

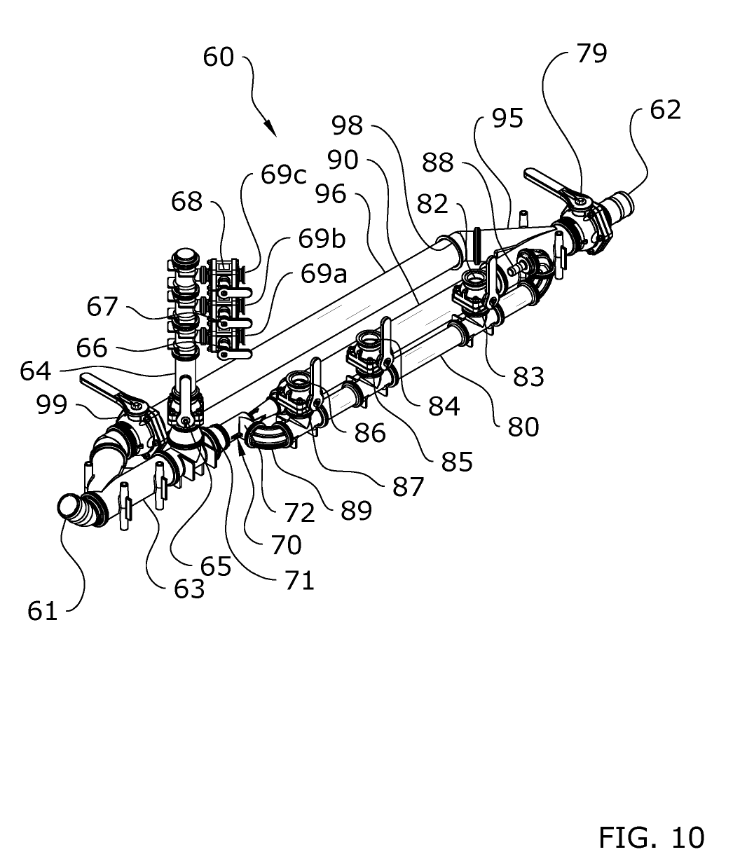

FIG. 11 is a rear perspective view of a transfer system for a batch preparation system in accordance with an example embodiment.

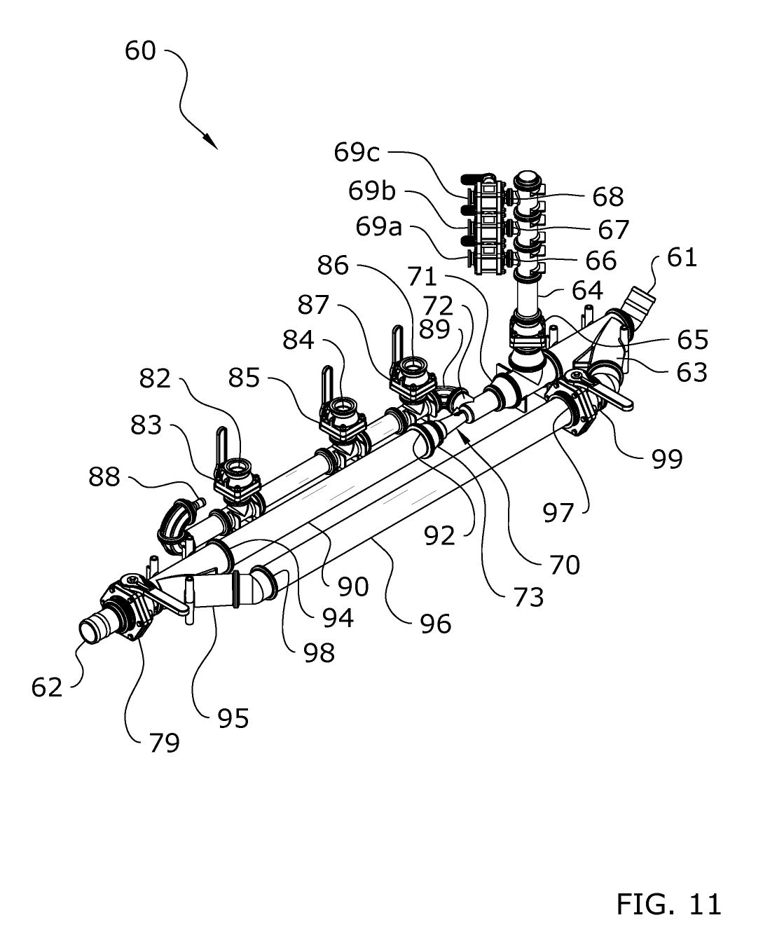

FIG. 12 is a top view of a transfer system for a batch preparation system in accordance with an example embodiment.

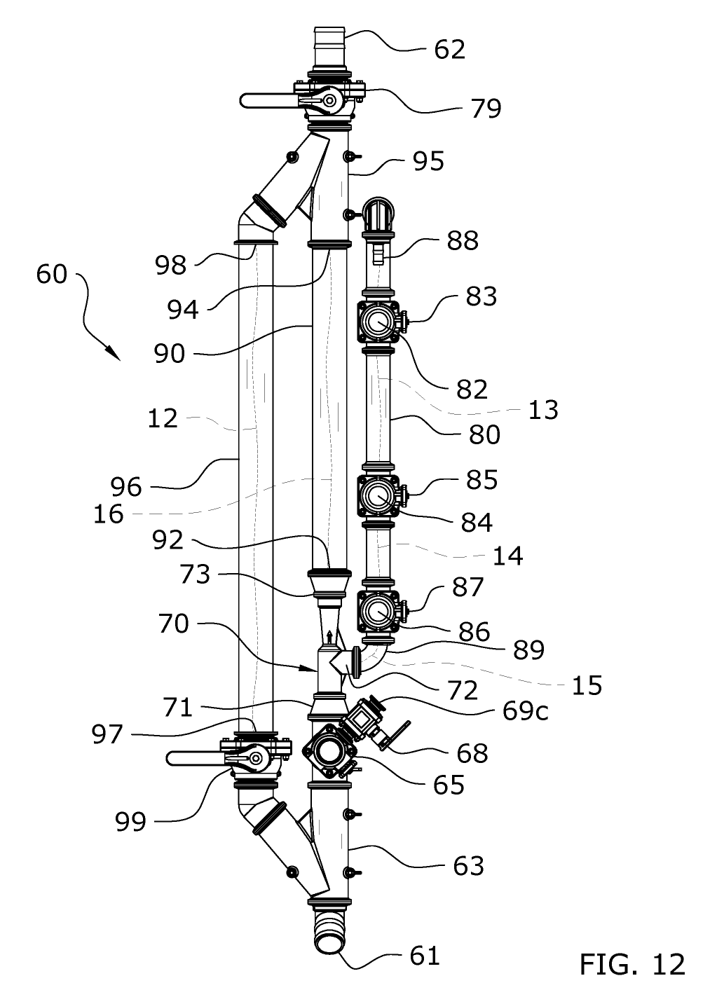

FIG. 13 is a block diagram of a batch preparation system in accordance with an example embodiment.

FIG. 14 is a flowchart illustrating loading of the tanks.

FIG. 15 is a flowchart illustrating mixing of materials in the transfer system.

FIG. 16 is a flowchart illustrating rinsing of the manifold.

FIG. 17 is a flowchart illustrating rinsing of the tanks.

FIG. 18 is a flowchart illustrating usage of a wand sprayer.

### DETAILED DESCRIPTION

### A. Overview.

An example batch preparation system generally comprises a frame 20, a tank unit 30 comprising a plurality of tanks 40, 44, 50 connected to the frame 20, and a transfer system 60 for mixing materials 13, 14, 15 stored in the tanks 40, 44, 50 with fluids 12 being transferred such as by pumping, pouring, or flowing, from a fluid source 17. The tanks 40, 44, 50 are interconnected to form a unitary tank unit 30 which is positioned on the frame 20. Each tank 40, 44, 50 includes a hopper 41, 45, 51 and fluidly connects through a manifold valve 83, 85, 87 into a manifold pipe 80.

The transfer system 60 includes a manifold pipe 80 which is fluidly connected to each of the tanks 40, 44, 50. An eductor 70 is connected to the manifold pipe 80 such that the materials 13, 14, 15 from each tank 40, 44, 50 are drawn by suction through the eductor 70 into a mixing conduit 90, where the materials 13, 14, 15 are mixed with the fluid 12 from the pump 18. The resulting mixture 16 is dispensed through a transfer outlet 62, such as to a reservoir tank 11.

The figures and description herein include reference to a number of valves 65, 66, 67, 68, 79, 83, 85, 87, 99. The valves 65, 66, 67, 68, 79, 83, 85, 87, 99 are shown as comprising handle-actuated valves 65, 66, 67, 68, 79, 83, 85, 87, 99 which are opened or closed by turning a handle. It should be appreciated that this is merely for exemplary purposes only. Various types of 65, 66, 67, 68, 79, 83, 85, 87, 99 which control flow of a concentrate may be utilized. The valves 65, 66, 67, 68, 79, 83, 85, 87, 99 may be manually or automatically adjusted. Although handle-actuated valves 65, 66, 67, 68, 79, 83, 85, 87, 99 are shown, in some embodiments, a control system such as a computing device may be configured to automatically open or close the valves 65, 66, 67, 68, 79, 83, 85, 87, 99 during operations of the present invention.

### B. Frame.

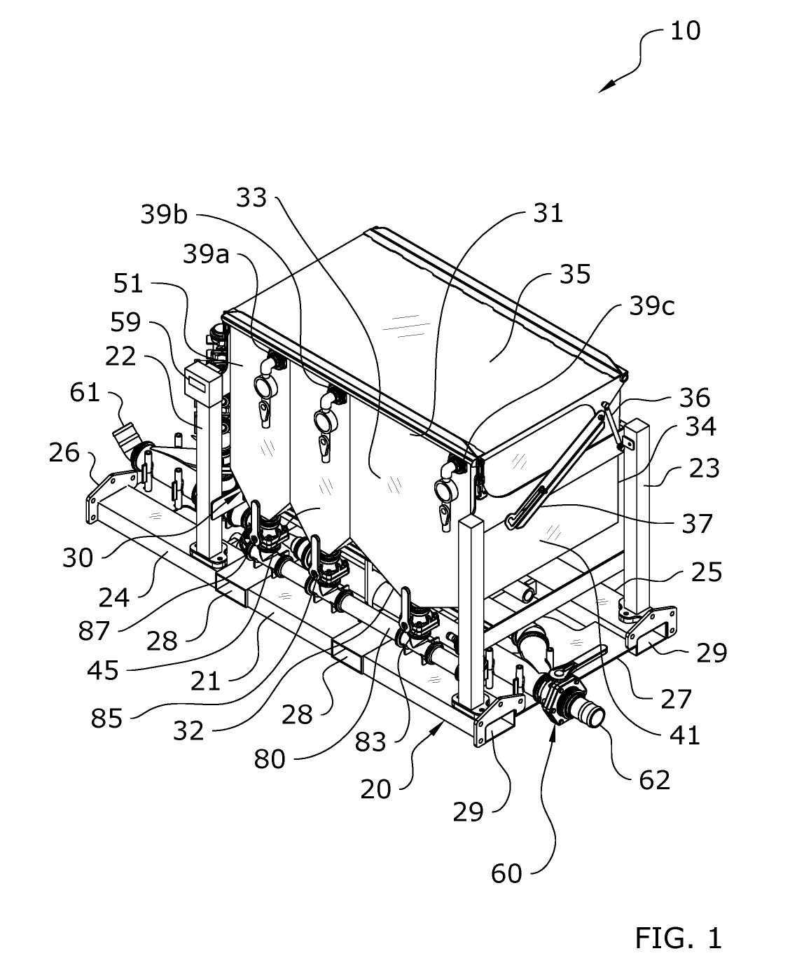

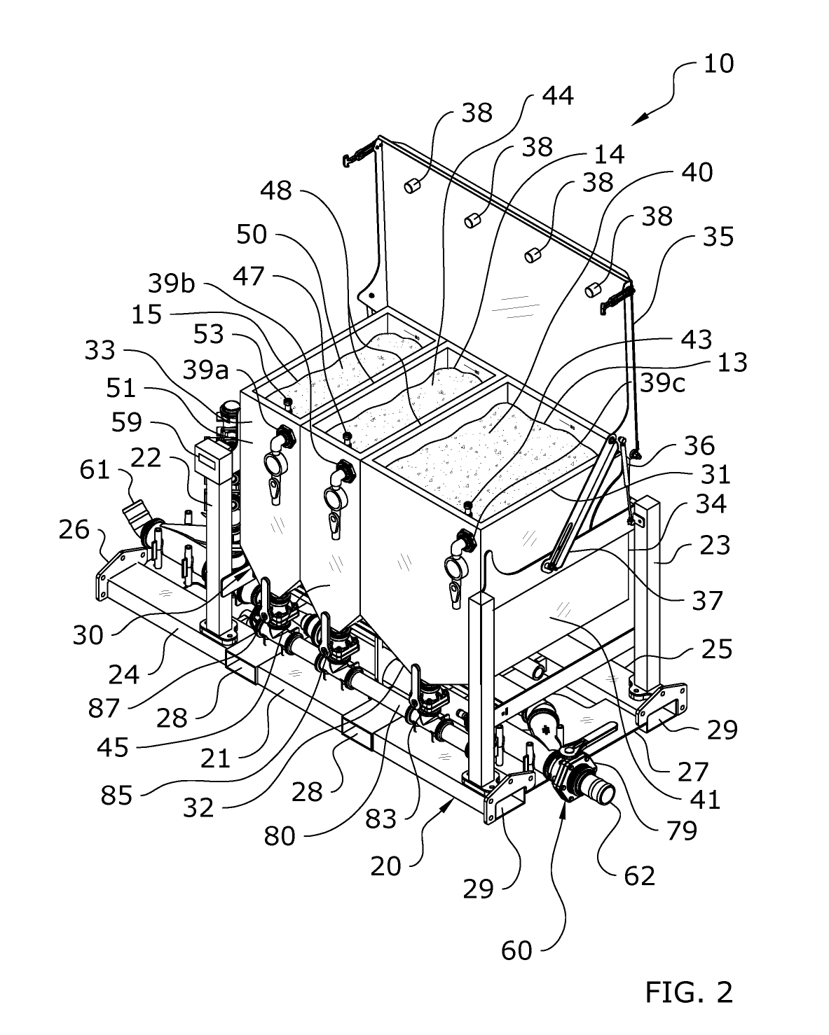

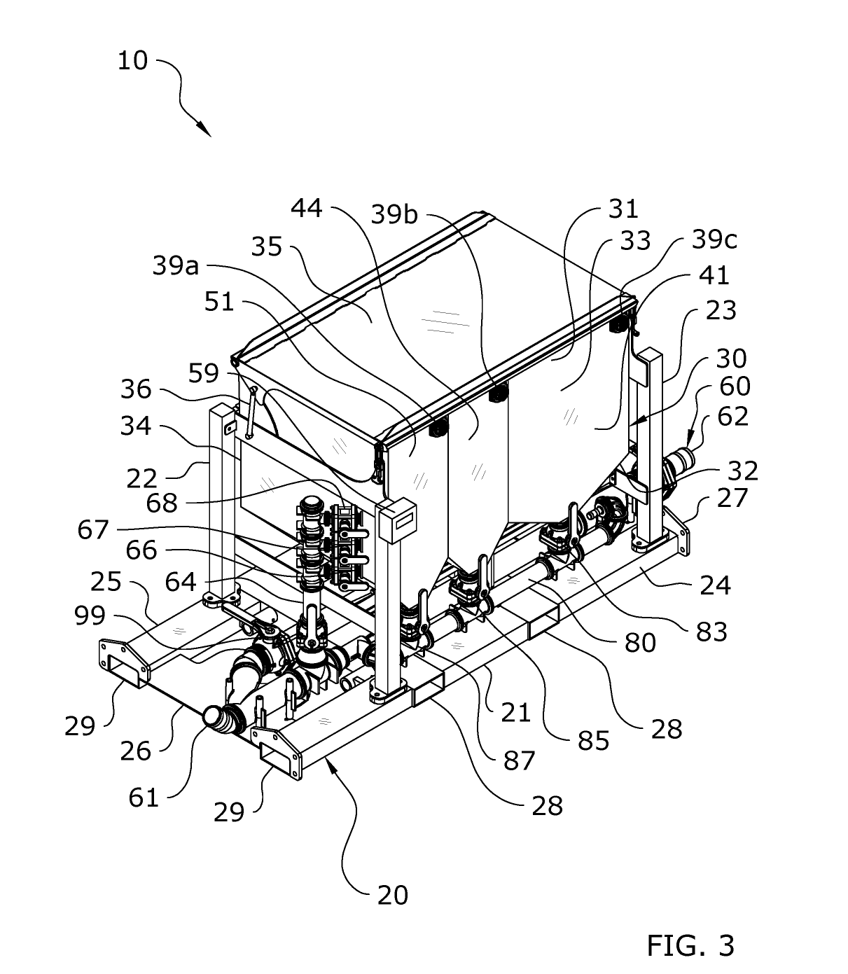

As shown in FIGS. 1-3, a frame 20 is generally provided which supports the tank unit 20 and the transfer system 60 of the batch preparation system 10. The structure, configuration, and size of the frame 20 may vary in different embodiments. Preferably, the frame 20 will be compact so that it may be easily transported, such as on a trailer. The frame 20 is preferably designed to be mobile so that the batch preparation system 10 may be easily transported between sites.

As shown in the figures, the frame 20 will generally comprise a front end 24, a rear end 25, a first side 26, and a second side 27. The first side 26 of the frame 20 may comprise a first side support 22 as shown in the figures. The second side 27 of the frame 20 may comprise a second side support 23 as shown in the figures. As shown in FIG. 1, the tank unit 30 rests upon a lower frame support 21 of the frame 20. The first and second side supports 22, 23 of the frame 20 aid in supporting the tank unit 20 on the frame 20.

The frame 20 is preferably adapted to be easily transportable. Any number of methods of transport may be utilized. Because the tanks 40, 44, 50 are interconnected or integrally formed to comprise the complete, unified tank unit 20, it is simply a matter of transporting a singular frame 20 holding the unified tank unit 30 rather than separately transporting individual tanks 40, 44, 50 as is common in the prior art.

An exemplary method of transport is shown in the figures. As shown in FIGS. 1-3, the frame 20 may include first receivers 28 and/or second receivers 29. The first receivers 28 generally extend between the front end 24 and the rear end 25 of the frame 20. The second receivers 29 generally extend between the first side 26 and the second side 27 of the frame 20.

The receivers 28, 29 comprise slots extending through the frame 20 into which a fork lift may be inserted to reposition the frame 20. For example, a forklift may be utilized in combination with the first or second receivers 28, 29 to lift the frame 20 onto a trailerbed for transport. The use of both first receivers 28 and second receivers 29 allows for flexibility in how the frame 20 is lifted and how a forklift, for example, would need to be positioned to pick up the frame 20.

### C. Tank Unit.

As shown throughout the figures, a tank unit 30 is provided which is adapted to receive, store, and dispense a plurality of different materials 13, 14, 15. The tank unit 30 is preferably comprised of a unified structure having an upper end 31, a lower end 32, a front end 33, and a rear end 34 as shown in FIGS. 1-3.

The shape, structure, size, and configuration of the tank unit 30 may vary in different embodiments. Thus, the tank unit 30 should not be construed as limited by the exemplary embodiment shown in the figures, as a wide range of versatility with respect to the dimensions, shape, configuration, and size of the tank unit 30 are necessary to accommodate different applications.

The tank unit 30 will preferably include a cover 35 which is hingedly connected to selectively cover the upper end 31 of the tank unit 30. One or more hinges 36 may be connected between the upper end 31 of the tank unit 30 and the cover 35 for the hinged connection. Locking mechanisms 37 may be provided which will retain the cover 35 locked in an open position or locked in a closed position. It is preferable to at least have a locking mechanism 37 to hold the cover 35 in an opened position when top-filling the tanks 40, 44, 50. However, the cover 35 may be omitted in some embodiments.

The cover 35 of the tank unit 30 may include projections 38 extending downwardly from the cover's 35 bottom surface as shown in the figures. These projections 38 will depress the rinse nozzles 43, 47, 53 in each tank 40, 44, 50 to selectively activate the rinse nozzles 43, 47, 53 as discussed herein. In embodiments which do not utilize rinse nozzles 43, 47, 53, the projections 38 may be omitted from the cover 35 of the tank unit 30.

The tank unit 30 will generally comprise a plurality of tanks 40, 44, 50. Each tank 40, 44, 50 is adapted to store a material 13, 14, 15 to be mixed together and dispensed out of the transfer outlet 62 of the transfer system 60 into a reservoir tank 11. Various types of materials 13, 14, 15 may be utilized, including liquids and/or solids. The materials 13, 14, 15 could comprise organic or inorganic materials such as chemicals, biological materials, dirt, debris, or any other material capable of being mixed together. Thus, the scope of the present invention should not be construed as limited to any particular materials 13, 14, 15.

The figures illustrate an exemplary embodiment having a first tank 40, a second tank 44, and a third tank 50. The number, positioning, and size of the tanks 40, 44, 50 may vary in different embodiments. The tank unit 30 could have any number of tanks 40, 45, 50; with three being shown in the figures merely for exemplary purposes. The sizes of the tanks 40, 45, 50 may vary for different application as well. For example, as shown in the exemplary figures, the first tank 40 could be adapted to hold a larger volume of materials than the second and third tanks 44, 50.

It should be appreciated that the tank unit 30 could comprise discrete tanks 40, 44, 50 which are welded or otherwise connected together to form a unitary tank unit 30. In other embodiments, the tank unit 30 could comprise a singular tank structure which includes a plurality of dividers 48 which divide the tank unit 30 into multiple tanks 40, 44, 50.

In either case, it is preferable that the tanks 40, 44, 50 be interconnected or integrally formed such that they combine to form the unitary tank unit 30 structure which may be easily positioned on the frame 20 for transport. The figures illustrate a singular tank cover 35 which covers all of the tanks 40, 44, 50 of the tank unit 30. It should be appreciated that, in some embodiments, each tank 40, 44, 50 of the tank unit 30 may have its own separate tank cover 35.

As discussed in more detail below, the tanks 40, 44, 50 may be top-filled, such as by pouring or other dispensing materials 13, 14, 15 such as chemicals into the tanks 40, 44, 50 through the upper end 31 of the tank unit 30. For example, a first material 13 may be poured into the first tank 40 through the upper end 31 of the tank unit 30 when the cover 35 is raised. Similarly, a second material 14 may be poured into the second tank 44 and a third material 15 may be poured into the third tank 50.

Alternatively, the tanks 40, 44, 50 may be filled by utilizing fill ports 39 which may be positioned on the front end 33 of the tank unit 30; with each tank 40, 44, 50 having its own fill port 39 as shown in the figures. The fill ports 39 may be directly fed via a tube or other conduit, or liquid flow meters 56 may be utilized to measure how much materials are being filled into each tank 40, 44, 50.

Each of the tanks 40, 44, 50 preferably includes a hopper 41, 45, 51 comprising inwardly-slanting walls that converge into a tank outlet 42, 46, 52. The first tank 40 includes a first hopper 41 converging into a first tank outlet 42, the second tank 44 includes a second hopper 45 converging into a second tank outlet 46, and the third tank 50 includes a third hopper 51 converging into a third tank outlet 47.

Preferably, the tank outlets 42, 46, 52 are positioned at the lower end 32 of the tank unit 30 in each respective tank 40, 44, 50. The hoppers 41, 45, 51 each have aggressively-angled sides to gravity-feed the materials 13, 14, 15 into the manifold 80 when the valves 83, 85, 87 of the manifold 80 are in the open position. Using a gravity-feed method of distributing the materials 13, 14, 15 such as chemicals out of the tanks 40, 44, 50 and into the manifold 80 increases the efficiency of the system overall, including less fill time and less energy used.

As shown in the figures, a scale such as weigh bars 58 may be provided to display a weight for the tank unit 30. The weigh bars 58 may be connected to the frame 20 underneath the tank unit 30 so that the weight of the tank unit 30 may be shown on a display 59. The display 59 could be remote, such as a mobile phone, or could be connected directly to the tank unit 30 or the frame 20.

It should be appreciated that weigh bars 58 are merely an exemplary method of monitoring the weight of the tank unit 30. Various other weight sensors may be utilized. Further, although the figures illustrate weigh bars 58 configured to take a single weight for the entire tank unit 30, some embodiments may have separate weigh bars 58 for each individual tank 40, 44, 50 so that individual tank weights may be attained on-the-fly.

### D. Transfer System.

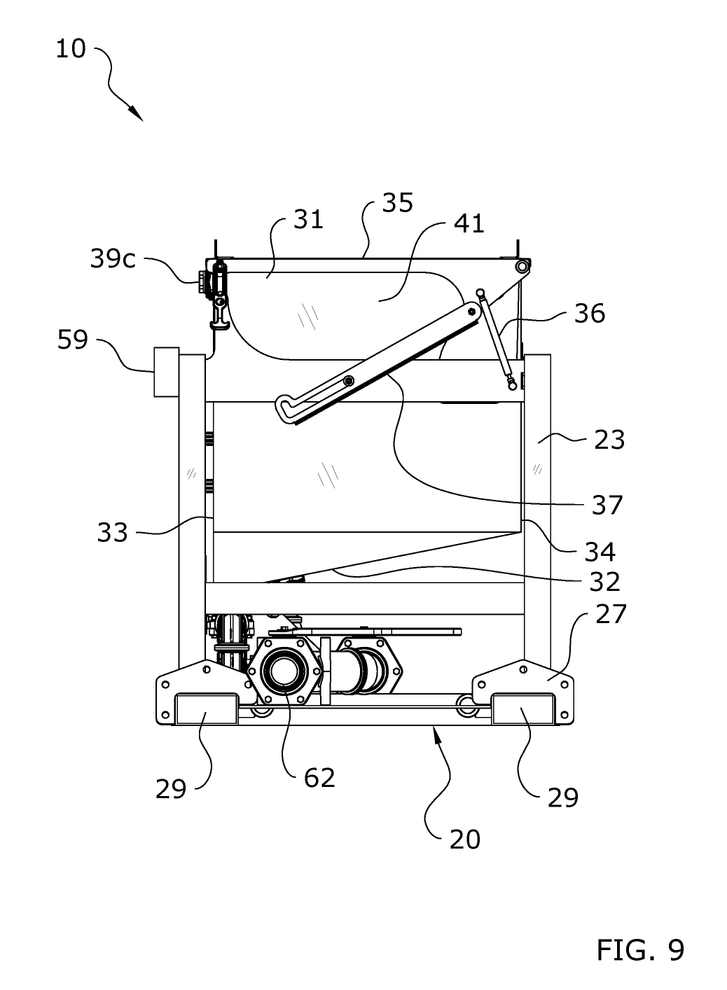

FIG. 9 illustrates an exemplary transfer system 60 for use with the batch preparation system 10. The transfer system 60 takes fluid 12 from a fluid source 17 in through a transfer inlet 61 and mixes one or more materials 13, 14, 15 into the fluid 12 before dispensing the mixture 16 out of the transfer outlet 62. The transfer system 60 also may include an integrated rinsing subsystem for rinsing the various components of the batch preparation system 10 as described herein.

The transfer system 60 may include a transfer inlet 61 which is connected to a pump 18; with the pump 18 being connected to draw fluid 12 such as water from a fluid source 17 such as a water reservoir or water tank. Flow from the transfer inlet 61 may be split to feed into a rinse conduit 64, a mixing conduit 90 via an eductor 70, and/or a clean fluid conduit 96 as will be discussed herein.

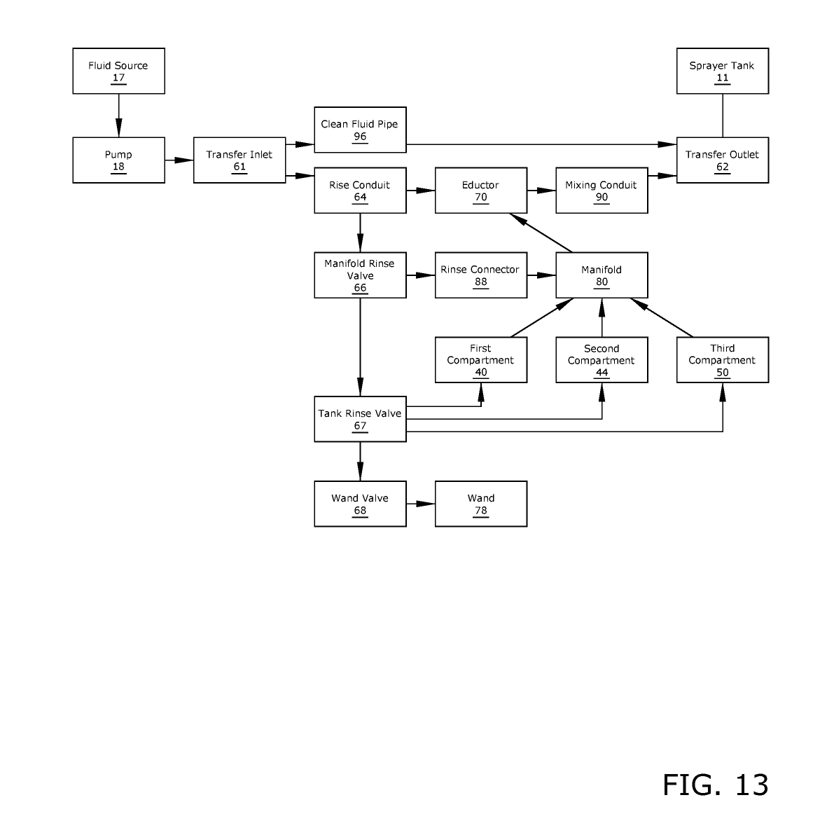

FIG. 13 shows an exemplary block diagram illustrating an exemplary flowpath for the fluids 12, chemicals 13, 14, 15, and mixture 16. As shown, a branch connector 63 may be connected to the transfer inlet 61 of the transfer system 60 so as to split the fluids 12 between a first path through the clean fluid conduit 96 and a second path through the rinse conduit 64, eductor 70, and mixing conduit 90.

The rinse conduit 64 is shown as extending upwardly from the inlet flow of fluids 12. The rinse conduit 64 is preferably positioned before the eductor 70 so that only clean, unmixed fluids 12 such as water will flow through the rinse conduit 64. The rinse conduit 64 may be positioned at any location along the transfer system 60 which pulls clean fluids 12, and should not be construed as limited in its placement by the exemplary figures.

The rinse conduit 64 pulls clean fluids 12 to be applied to rinse the various components of the transfer system 60. A rinse valve 65 may be positioned at the start of the rinse conduit 64 so as to control flow of fluids 12 through the rinse conduit 64. The rinse valve 65 will control the rinsing system overall: if the rinse valve 65 is closed, then no fluids 12 will flow into the rinse conduit 64 and thus the rinsing system will be disabled.

After the rinse valve 65, the rinse conduit 64 may include additional valves 66, 67, 68 which lead to rinse outlets 69 for the manifold 80, tanks 40, 44, 50, and a spray wand 78. It should be appreciated that these are merely exemplary configurations, and that additional rinsing systems may be utilized or some of the rinsing systems described herein may be omitted in some embodiments.

In the exemplary embodiment shown in the figures, the rinse conduit 64 includes a manifold rinse valve 66, a tank rinse valve 67, and a wand valve 68. The manifold rinse valve 66 controls a first rinse outlet 69a which is interconnected by a conduit such as a hose with the rinse connector 88 of the manifold 80. When both the rinse valve 65 and the manifold rinse valve 66 are open, clean fluids 12 will flow through the rinse conduit 64, the rinse valve 65, and the rinse connector 88 into the manifold 80. The clean fluids 12 will rinse out the manifold 80 and exit the manifold 80 through the suction inlet 72 of the eductor 70, where the rinsed out fluids will be expelled through the mixing conduit 90 and out the transfer outlet 62.

The tank rinse valve 67 allows for rinsing of the tanks 40, 44, 50 via the rinse nozzles 43, 47, 53. Thus, the tank rinse valve 67 controls a second rinse outlet 69b which is interconnected via conduits such as hoses with each of the rinse nozzles 43, 47, 53 within the tanks 40, 44, 50. When both the rinse valve 65 and the tank rinse valve 67 are open, clean fluids 12 will flow through the rinse conduit 64, the rinse valve 65, and the tank rinse valve 67 to each of the rinse nozzles 43, 47, 53. If the tank cover 35 is closed, thus engaging the projections 38 with the rinse nozzles 43, 47, 53, the rinse nozzles 43, 47, 53 will open to spray the clean fluids 12 into the tanks 40, 44, 50 to rinse the tanks 40, 44, 50 out. The rinsed fluids will exit the tanks 40, 44, 50 through the tank outlets 42, 46, 52, the manifold 80 and the eductor 70 to be expelled through the mixing conduit 90 and the transfer outlet 62.

The wand valve 68 controls a third rinse outlet 69c which is connected via a conduit such as piping to a wand sprayer 78. The wand sprayer 78 may be grasped by the hand of a user to manually rinse any components of the batch preparation system 10. For example, the exterior of the tank unit 30 and frame 20 may be cleaned with the hand-held wand sprayer 78. Clean fluids 12 will pass through the rinse valve 65, rinse conduit 64, and wand valve 68 to be expelled through the wand sprayer 78.

At a position after the rinse valve 65 and rinse conduit 64 in the flow path of the transfer system 60, an eductor 70 is positioned as shown in the figures. The eductor 70 utilizes the venturi effect to apply suction to a suction inlet 72. The eductor 70 will generally comprise a flow inlet 71, a suction inlet 72, and a diffuser outlet 73.

The clean fluid 12 flow from the transfer inlet 61 is directed into the flow inlet 71. The suction inlet 72 of the eductor 70 is connected to the manifold outlet 89 of the manifold 80 such that materials 13, 14, 15 within the manifold 80 will be drawn via vacuum force through the suction inlet 72 of the eductor 70 such that the materials 13, 14, 15 are mixed with the clean fluid 12 from the flow inlet 71 of the eductor 70. The resulting mixture 16 is expelled from the eductor 70 via the diffuser outlet 73 into the mixing conduit 90.

The materials 13, 14, 15 are drawn through the suction inlet 72 of the eductor 70 from a manifold 80. As shown throughout the figures, the manifold 80 is positioned directly underneath the tank unit 30. This configuration is preferable so that the manifold 80 may be gravity-fed materials 13, 14, 15 from the tanks 40, 44, 50; rather than requiring any suction or other outside force.

The manifold 80 will generally comprise a conduit such as piping which includes a plurality of inlets 82, 84, 86 being connected to the respective tank outlets 42, 46, 52 of each tank 40, 44, 50. The number of inlets 82, 84, 86 will generally match the number of tanks 40, 44, 50 in the tank unit 30. In the exemplary figures, the manifold 80 includes a first inlet 82 for the first tank 40, a second inlet 84 for the second tank 44, and a third inlet 86 for the third tank 50.

Each of the inlets 82, 84, 86 are preferably controlled by a manifold valve 83, 85, 87. Only when one the manifold valve 83, 85, 87 is open will materials 13, 14, 15 stored in the respective tanks 40, 44, 50 be gravity-fed by the hoppers 41, 45, 51 into the manifold 80. Thus, the first inlet 82 of the manifold 80 is connected to the first tank outlet 42 of the first tank 40 by a first manifold valve 83. The second inlet 84 of the manifold 80 is connected to the second tank outlet 46 by a second manifold valve 85. The third inlet 86 of the manifold 80 is connected to the third tank outlet 52 by a third manifold valve 87.

The manifold outlet 89 is connected to the suction inlet 72 of the eductor 70. Thus, as materials 13, 14, 15 are gravity-fed through the manifold inlets 82, 84, 86, they will be suctioned through the manifold outlet 89 into the eductor 70 to be mixed with the clean fluid 12 coming in through the flow inlet 71 of the eductor 70 and expelled as a mixture 16 through the diffuser outlet 73 of the eductor 70.

The manifold 80 will also generally include a rinse connector 88. The rinse connector 88 will preferably be positioned before the manifold inlets 82, 84, 86 and the manifold outlet 89 in the flowpath of the manifold 80. Clean fluids 12 from the rinse conduit 64 may be fed through the rinse connector 88 to rinse out the manifold 80 when needed as discussed.

The diffuser outlet 73 of the eductor 70 expels the misture 16 into a mixing conduit 90. The mixing conduit 90 comprises a length of conduit such as piping. The inlet 92 of the mixing conduit 90 is connected to the diffuser outlet 73 of the eductor 70 to receive the mixture 16. The outlet 94 of the mixing conduit 90 feeds directly into the transfer outlet 62 of the transfer system so that the mixture 16 can be dispensed from the transfer system, such as into a reservoir tank 11.

Shown throughout the figures is an optional clean fluid conduit 96 which extends parallel with respect to the mixing conduit 90. The clean fluid conduit 96 is connected between the transfer inlet 61 and the transfer outlet 62 to expel only clean fluids 12 from the pump 18 directly out of the transfer outlet 62. As discussed previously, a branch connector 63 may split flow after the transfer inlet 61 to feed clean fluids 12 directly into the clean fluid conduit 96. Similarly, an outlet connector 95 may bridge the clean fluid conduit 96 with the mixing conduit 90 upstream of the transfer outlet 62.

The inlet 97 of the clean fluid conduit 96 is fluidly connected to the branch connector 63 via a clean fluid valve 99. When the clean fluid valve 99 is open, clean fluid 12 will pass through the inlet 97 of the clean fluid conduit 96 and out of the outlet 98 of the clean fluid conduit 96 to be dispensed through the transfer outlet 62. When the clean fluid valve 99 is closed, no fluids 12 will pass through the clean fluid conduit 96.

### E. Operation of Preferred Embodiment.

In use, the frame 20 may be transported into position. A forklift may engage with the frame 20 via its receivers 28, 29 to lift the frame 20 up to be placed upon a trailer or truck. The trailer or truck may also be used to haul the water 12 (or other liquid) as well as the materials 13, 14, 15 to be mixed and loaded into the reservoir tank 11. The trailer or truck may then be moved, along with the fluid source 17 such as a water tank, to the location of the reservoir tank 11 to be loaded. The compact nature of the tank unit 30 and its placement on the unified frame 20 allows for the batch preparation system 10 to be easily transported or moved from location-to-location.

Once the frame 20 is in position, the tank unit 30 may be filled with materials 13, 14, 15 to be mixed. The tanks 40, 44, 50 may be filled with each material 13, 14, 15 in a number of manners. To top-fill the tanks 40, 44, 50, the tank cover 35 is lifted so that the upper end 31 of the tank unit 30 is opened up. The materials 13, 14, 15 may then be poured or otherwise dispensed through the upper end 31 of the tank unit 30 into the tanks 40, 44, 50. The materials 13, 14, 15 may be top-filled into the tanks 40, 44, 50 in premeasured or known quantities. This method of top-filling is particularly useful for materials 13, 14, 15 which are comprised of solids such as granular chemicals.

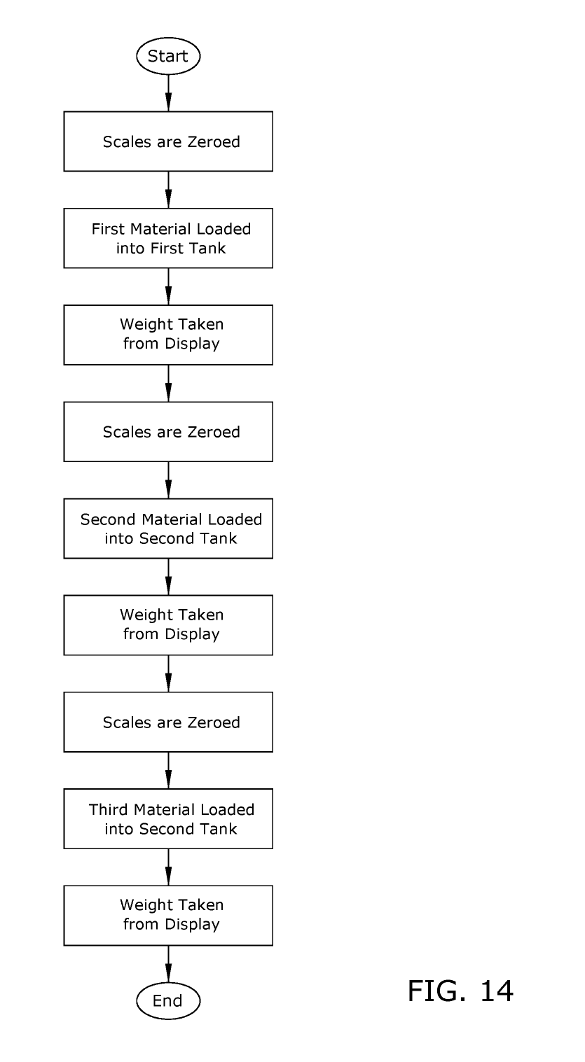

The weigh bars 58, if installed, may provide for precision top-filling of the tanks 40, 44, 50. To do so, the weigh bars 58 are first zeroed before placing any materials 13, 14, 15 in the tanks 40, 44, 50 as shown in FIG. 14. With the display 59 showing zero weight, the first material 13 may be dispensed into the first tank 40. The weight of the first material 13 may then be taken from the display 59, and then weigh bars 58 zeroed again. The second material 14 may then be dispensed into the second tank 50. The weight of the second material 14 may then be taken from the display 59, and then the weigh bars 58 may be zeroed again. With the display 59 again showing zero weight, the third material 15 may be dispensed into the third tank 50 to take a reading of the third material's 15 weight.

The tanks 40, 44, 50 may also be filled using the fill ports 39. Hoses may be connected directly to the fill ports 39 to dispense the materials 13, 14, 15 into the tanks 40, 44, 50. Alternatively, if the case of liquid materials 13, 14, 15, liquid flow meters 56 may be installed on the fill ports 39 to measure the amount of liquid materials 13, 14, 15 dispensed into each tank 40, 44, 50. During all filling operations, the manifold valves 83, 85, 87 should be closed to prevent premature mixing.

Once the tanks 40, 44, 50 are filled with the materials 13, 14, 15 to be mixed; the batching process may begin. The transfer inlet 61 is connected to the pump 18; with the pump 18 drawing clean fluids 12 such as water from a fluid source 17. The transfer outlet 62 is connected to the reservoir tank 11 to be filled.

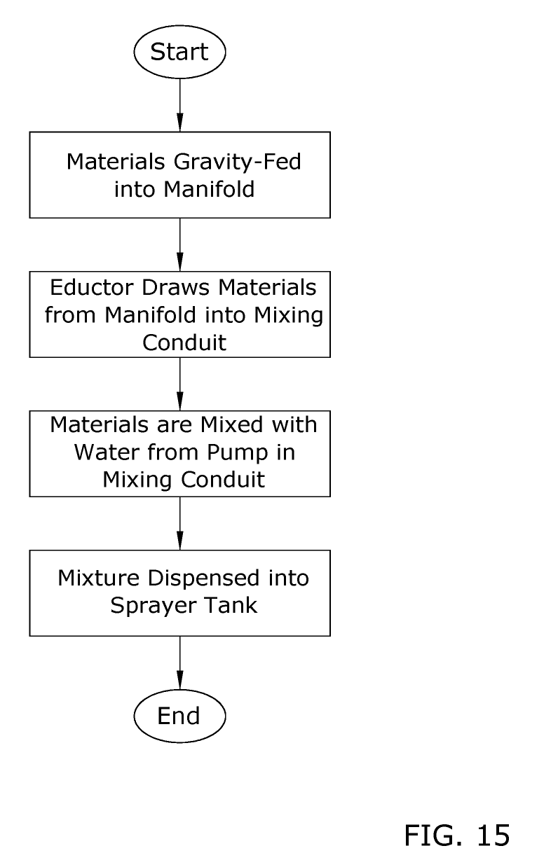

With fluid 12 flowing through the transfer system 60 via the pump 18, the manifold valves 83, 85, 87 may be opened individually or together. The materials 13, 14, 15 will be gravity-fed through the hoppers 41, 45, 51 and the tank outlets 42, 46, 52 into the manifold 80 as illustrated in FIG. 15. Suction is applied to the manifold 80 via the eductor 70 to draw the materials 13, 14, 15 through the manifold 80 and out of the manifold outlet 89 into the eductor 70. The diffuser outlet 73 of the eductor 70 will dispense the resulting mixture 16 of the materials 13, 14, 15 and the fluid 12 into the mixing conduit 90. If the outlet valve 79 is opened, the mixture 16 will then be dispensed out of the transfer system 60 into the reservoir tank 11.

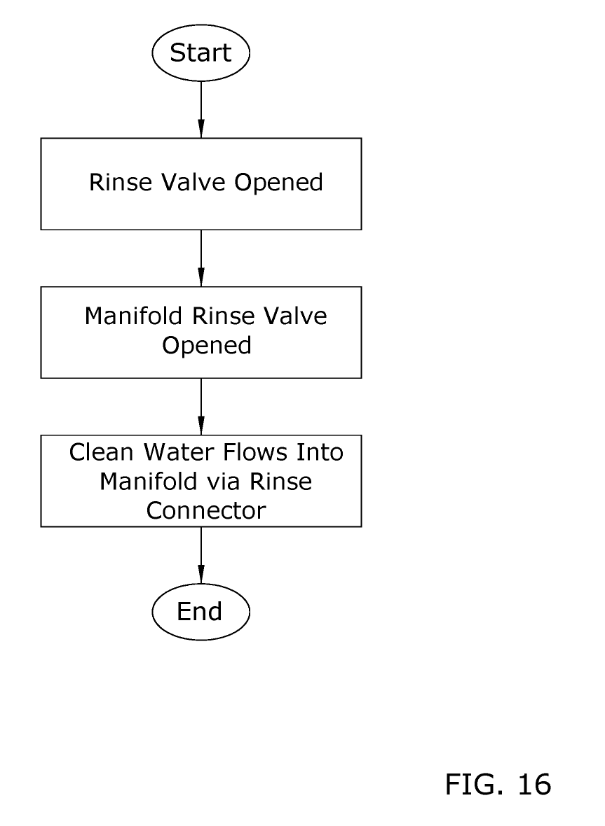

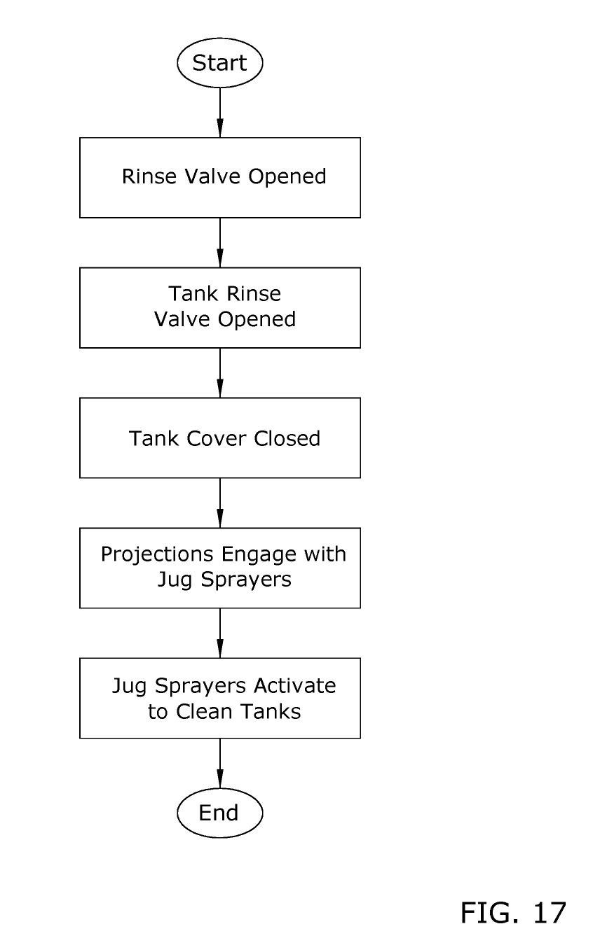

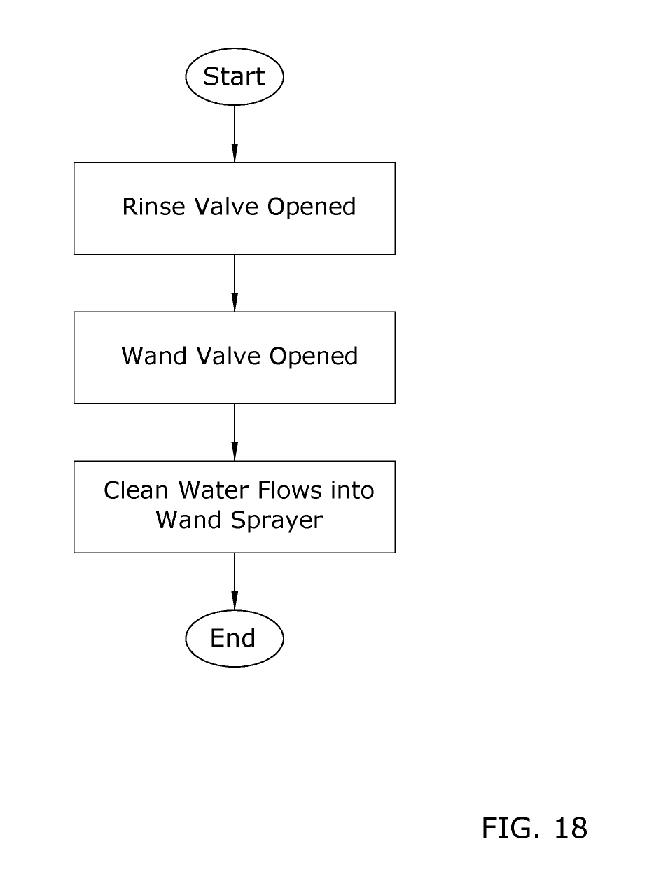

After dispensing the mixture 16, the transfer system 60 may be rinsed. FIGS. 16-18 illustrate various rinsing functions. The rinsing system may be activated by opening the rinse valve 65, which will direct clean fluid 12 through the rinse conduit 64. The manifold rinse valve 66 may be opened to direct the clean fluid 12 through the manifold 80 to rinse it out as described herein. The tank rinse valve 67 may be opened, and the tank cover 35 closed, to activate the rinse nozzles 43, 47, 53 to rinse the tanks 40, 44, 50. The wand valve 68 may be opened to direct clean fluid 12 through the wand 78 so that manual rinsing may be accomplished. Preferably, the present invention will be cleaned between each batching operation; with the tanks 40, 44, 50 being visibly clean within to prevent any cross-contamination.

Unless otherwise defined, all technical and scientific terms used herein have the same meaning as commonly understood by one of ordinary skill in the art to which this invention belongs. Although methods and materials similar to or equivalent to those described herein can be used in the practice or testing of the batch preparation system, suitable methods and materials are described above. All publications, patent applications, patents, and other references mentioned herein are incorporated by reference in their entirety to the extent allowed by applicable law and regulations. The batch preparation system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A material batching system, comprising:
a pump fluidly connected to a fluid source;
a plurality of tanks, each of the tanks being adapted to receive and store a material;
a manifold pipe fluidly connected to an outlet of each of the tanks;
a mixing pipe for mixing a fluid from the fluid source with the material from the tanks; and
an eductor comprising a feed inlet, a suction inlet, and a diffuser outlet, wherein the feed inlet is fluidly connected to the pump, wherein the suction inlet is fluidly connected to the manifold pipe, and wherein the diffuser outlet is fluidly connected to an inlet of the mixing pipe;
wherein the material is adapted to be drawn by suction through the manifold and eductor into the mixing pipe to be mixed with the fluid.

2. The system of claim 1, wherein the plurality of tanks are connected together to form a unitary tank unit.

3. The system of claim 1, further comprising a frame, wherein the tanks, the manifold pipe, the eductor, and the mixing pipe are connected to the frame.

4. The system of claim 3, wherein the frame comprises at least one receiver for receiving a forklift.

5. The system of claim 1, further comprising a rinse conduit fluidly connected to the pump.

6. The system of claim 5, wherein the rinse conduit comprises a manifold rinse outlet, wherein the manifold rinse outlet is fluidly connected to a rinse connector on the manifold.

7. The system of claim 5, wherein the rinse conduit comprises a tank rinse outlet.

8. The system of claim 7, wherein each of the tanks includes a rinse nozzle.

9. The system of claim 8, wherein the tank rinse outlet of the rinse conduit is fluidly connected to the rinse nozzle of each of the tanks.

10. The system of claim 5, wherein the rinse conduit comprises a wand outlet, wherein the wand outlet is fluidly connected to a wand sprayer.

11. The system of claim 1, wherein each of the tanks comprises a hopper.

12. The system of claim 11, wherein the outlet of each of the tanks is positioned at a lower end of the hopper of each of the tanks.

13. The system of claim 12, wherein the manifold pipe is positioned underneath the tanks.

14. The system of claim 1, further comprising a tank cover hingedly connected to an upper end of the tanks.

15. A material batching system, comprising:
a pump fluidly connected to a fluid source;
a frame;
a tank unit comprising a plurality of tanks connected to the frame, each of the tanks being adapted to receive and store a material;
a manifold pipe extending underneath the tank unit, wherein the manifold pipe is fluidly connected to an outlet of each of the tanks;
a mixing pipe for mixing a fluid from the fluid source with the material from the tanks; and
an eductor comprising a feed inlet, a suction inlet, and a diffuser outlet, wherein the feed inlet is fluidly connected to the pump, wherein the suction inlet is fluidly connected to the manifold pipe, and wherein the diffuser outlet is fluidly connected to an inlet of the mixing pipe;
wherein the material is adapted to be drawn by suction through the manifold and eductor into the mixing pipe to be mixed with the fluid.

16. The system of claim 15, wherein each of the tanks comprises a hopper, wherein each outlet of each of the tanks is positioned at a lower end of the hopper of each of the tanks.

17. The system of claim 15, wherein each tank includes a fill port for receiving the material.

18. The system of claim 17, further comprising a liquid flow meter connected to each fill port of each tank.

19. The system of claim 15, further comprising a rinse valve connected to a rinse conduit for cleaning the tanks, manifold pipe, and mixing pipe.

20. The system of claim 19, wherein the rinse conduit comprises a manifold rinse valve fluidly connected to a rinse connector on the manifold pipe, a tank rinse valve fluidly connected to a rinse nozzle in each of the tanks, and a wand valve fluidly connected to a wand sprayer.
